(19) United States
(12) Patent Application Publication
(10) Pub. No.: US 2018/0159335 A1
(43) Pub. Date: Jun. 7, 2018

(54) ELECTRIC POWER GENERATION CONTROL DEVICE, CONTROL DEVICE, CONTROL METHOD AND RECORDING MEDIUM

(71) Applicant: NEC CORPORATION, Tokyo (JP)

(72) Inventors: Kosuke HOMMA, Tokyo (JP); Koji KUDO, Tokyo (JP); Katsuya SUZUKI, Tokyo (JP); Noriaki KOBAYASHI, Tokyo (JP)

(73) Assignee: NEC CORPORATION, Tokyo (JP)

(21) Appl. No.: 15/574,532

(22) PCT Filed: Aug. 28, 2015
(86) PCT No.: PCT/JP2015/074391

§ 371 Date: Nov. 16, 2017

(30) Foreign Application Priority Data
May 27, 2015 (JP) 2015-107738

(51) Int. Cl. H02J 3/46; H02J 13/00; G05B 13/02

(52) U.S. Cl. CPC H02J 3/46; H02J 3/383; G05B 13/026; H02J 13/0096

(57) ABSTRACT

An electric power generation control device is provided with: a communication unit that receives an output upper-limit value in a power generation device group and a predicted amount of power generation of each power generation device that belongs to the power generation device group; and a determination unit that, on the basis of the output upper-limit value and the predicted amount of power generation of each power generation device, determines a first output upper-limit value of each power generation device that makes the sum total of the output of each power generation device equal to or less than the output upper-limit value.

### TECHNICAL FIELD

The present invention relates to an electric power generation control device, a control device, a control method, and a recording medium.

### BACKGROUND ART

An electric power system is known that is connected to power generation devices (hereinbelow also referred to as “renewable energy power sources”) that use the renewable energy of, for example, a solar power generation device or wind power generation device to generate electric power.

In an electric power system that is connected to renewable energy power sources, the necessity arises of reducing the output (electric power supply) of power generation devices such as renewable energy power sources when the electric power supply exceeds the electric power demand.

In Patent Document 1, an electric power system control system is disclosed that reduces the output of PV (Photovoltaic power generation) devices that are connected to the electric power system.

In this electric power system control system, a plurality of PV devices is grouped on the basis of the rated output of the PV devices. This electric power system control system then reduces the output of the PV devices in group units to satisfy the balance between electric power supply and demand.

### LITERATURE OF THE PRIOR ART

### Patent Documents

Patent Document 1: JP 5460622 B

### SUMMARY

### Problem to be Solved by the Invention

Because the power generation of a renewable energy power source is influenced by the environment, (such as the weather), there is concern regarding the ability to implement power generation according to plan. As a result, in the electric power system control system disclosed in Patent Document 1, the amount of generated power that is generated becomes insufficient when the reduction of output power is greater than the actual amount of output power that is demanded, and the amount of generated power that is generated exceeds and surpasses the upper-limit value when the reduction of output power is not enough to meet actual power generation requirements. It is therefore desirable to have a technology that enables accurate planning to when reducing output power for power generation devices.

It is an object of the present invention to provide an electric power generation control device, a control device, a control method, and a recording medium that can provide a solution to the above-described problems.

### Means for Solving the Problem

An exemplary aspect of the electric power generation control device of the present invention is provided with a communication unit that receives an output upper-limit value in a power generation device group and a predicted amount of power generation of each power generation device that belongs to the power generation device group; and a determination unit that, on the basis of the output upper-limit value and the predicted amount of power generation of each of the power generation devices, determines a first output upper-limit value of each of the power generation devices that makes the sum total of the outputs of each of the power generation devices equal to or less than the output upper-limit value.

An exemplary aspect of the electric power generation control device of the present invention is provided with a communication unit that receives the output upper-limit value in a power generation device group, and a determination unit that, on the basis of the output upper-limit value in the power generation device group and the capacity that can be output by each of the power generation devices that has been determined in advance, determines a first output upper-limit value of each power generation device that makes the sum total of the output of each of the power generation devices equal to or less than the output upper-limit value.

An exemplary aspect of the control method of the present invention includes steps of: receiving an output upper-limit value in a power generation device group and the predicted amount of power generation of each power generation device that belongs to the power generation device group and, on the basis of the output upper-limit value and the predicted amount of power generation of each of the power generation devices, determining a first output upper-limit value of each of the power generation devices that makes the sum total of the output of each of the power generation devices equal to or less than the output upper-limit value.

An exemplary aspect of the recording medium of the present invention is a recording medium that can be read by a computer and on which is recorded a program for causing a computer to execute a reception procedure of receiving an output upper-limit value in a power generation device group and a predicted amount of power generation of each power generation device that belongs to the power generation device group and a determination procedure of, on the basis of the output upper-limit value and the predicted amount of power generation of each of the power generation devices, determining a first output upper-limit value of each of the power generation devices that makes the sum total of the output of each of the power generation devices equal to or less than the output upper-limit value.

### Effect of the Invention

The present invention enables accurate planning to when reducing output power for power generation devices.

### BRIEF DESCRIPTION OF THE DRAWINGS

FIG. 1 is a block diagram of the first example embodiment of the present invention.

FIG. 2 is a view for describing the relation between probability distribution and the output upper-limit value.

FIG. 3 is a chart showing a reduction in the flow of the output power of the first example embodiment of the present invention.

FIG. 4 shows an example of a renewable energy power source.

FIG. 5 is a block diagram showing electric power generation control device Aa of the second exemplary embodiment of the present invention.

FIG. 6 is a block diagram showing electric power generation control device Ab of the third exemplary embodiment of the present invention.

### EXAMPLE EMBODIMENT

Example embodiments of the present invention are next described with reference to the accompanying drawings.

### First Example Embodiment

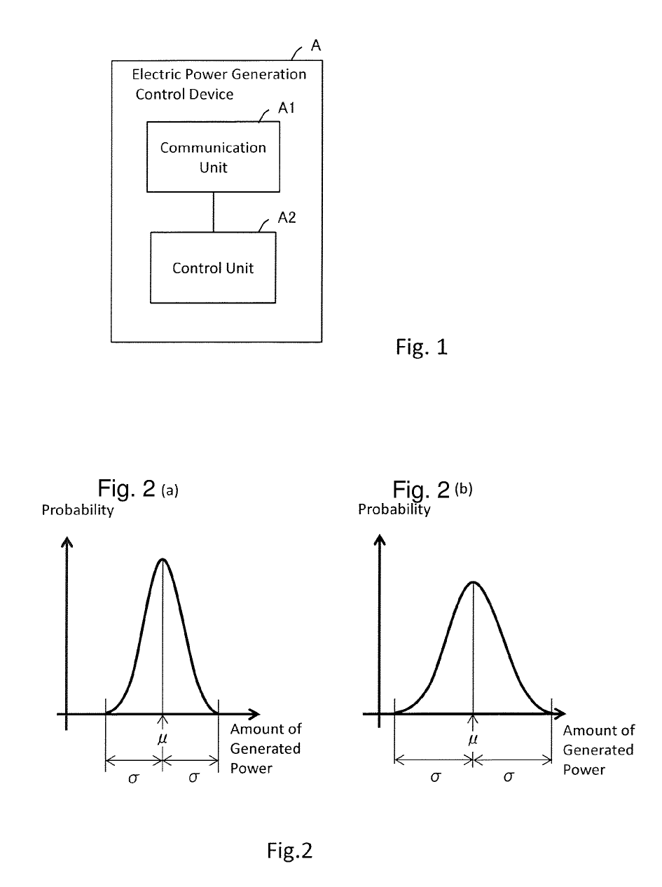

FIG. 1 is a block diagram showing the first example embodiment of the present invention. As shown in FIG. 1, the output control system of power generation that uses renewable energy in the first example embodiment includes electric power generation control device A. Electric power generation control device A is provided with communication unit A1 and control unit A2. Electric power generation control device A is able to communicate with a plurality of renewable energy power sources within the electric power system over which it has jurisdiction. Here, “renewable energy power source” refers to a power generation device (renewable energy power generation device) that uses renewable energy to generate electric power. A plurality of renewable energy power sources is an example of a power generation device group.

Communication unit A1 receives output upper-limit value M in a power generation device group that is made up of a plurality of renewable energy power sources and a probability distribution (for example, a probability density function) for the predicted amount of power generation of each renewable energy power source that belongs to the power generation device group. The probability distribution for the predicted amount of power generation of renewable energy power sources is hereinbelow also referred to as simply “a probability distribution”. In addition, output upper-limit value M in a power generation device group is also referred to as “output upper-limit value M” or “M”.

A probability distribution is generated for each renewable energy power source in a prediction device (not shown in the figure) using the power generation history of the renewable energy power source. The prediction device transmits each probability distribution to communication unit A. The prediction device is managed by, for example, a power company. The prediction device need not be managed by a power company, and may alternatively be incorporated in electric power generation control device A.

In a probability distribution, average value μ of the predicted amount of power generation of a renewable energy power source and dispersion value σ of the predicted amount of power generation of the renewable energy power source are uniquely specified. As a result, a probability distribution indicates the average value μ of the predicted amount of power generation of a renewable energy power source and the dispersion value σ of the predicted amount of power generation of the renewable energy power source. In the following explanation, average value μ of the predicted amount of power generation of a renewable energy power source is also referred to as “average value μ” or “μ,” and the dispersion value σ of the predicted amount of power generation of the renewable energy power source is also referred to as “dispersion value σ” or “σ”.

Control unit A2 is one example of the determination unit.

On the basis of output upper-limit value M and the probability distribution, control unit A2 determines the output upper-limit value (first output upper-limit value) of each renewable energy power source that makes the sum total of the output of each renewable energy power source equal to or less than output upper-limit value M. For example, control unit A2 determines the output upper-limit value (first output upper-limit value) of each renewable energy power source on the basis of output upper-limit value M and the average value μ and dispersion value σ of each renewable energy power source.

In addition, control unit A2 determines an output upper-limit value (second output upper-limit value) of each renewable energy power source that both decreases the difference in the degree of output control among renewable energy power sources, and further, makes the sum total of the output of each renewable energy power source equal to or less than output upper-limit value M. For example, control unit A2 determines the output upper-limit value (second output upper-limit value) of each renewable energy power source on the basis of output upper-limit value M and average value μ and dispersion value σ of each renewable energy power source.

Examples are next described regarding the relation between the probability distribution and the output upper-limit value that is determined by control unit A2.

### First Example

In the case of FIG. 2(a), because the breadth of the probability distribution is narrower (dispersion value σ is smaller) than in the case of FIG. 2(b), the probability of renewable energy power source generating power at average value μ is higher than in FIG. 2(b). As a result, for each renewable energy power source, control unit A2 determines a value obtained by subtracting an adjustment value that increases in proportion to the size of dispersion value σ from average value μ as the output upper-limit value (permissible amount of power generation) of the renewable energy power source.

### Second Example 2

Control unit A2 determines the output upper-limit value (permissible amount of power generation) taking as a standard the predicted minimum amount of power generation that is specified based on the probability distribution. To give an example, control unit A2 determines as the output upper-limit value (permissible amount of power generation) of a renewable energy power source, within a range that is equal to or less than the predicted minimum amount of power generation specified on the basis of the probability distribution, a value for which the difference from the predicted minimum amount of power generation is within a predetermined value.

On the other hand, the prediction accuracy of the amount of power generation is lower in the case of FIG. 2(b) than in the case of FIG. 2(a). As a result, under circumstances in which, for example, average value μ is identical for the cases of FIG. 2(a) and FIG. 2(b), there is the concern that power generation according to planning that accords with the output upper-limit value will not be possible even when the same output upper-limit value is determined in the case of FIG. 2(b) as for the case of FIG. 2(a). As a result, in the case of FIG. 2(b), control unit A2 determines an output upper-limit value that is lower than the output upper-limit value for the case of FIG. 2(a). As an example, control unit A2 determines as the output upper-limit value (permissible amount of power generation), within a range that is no greater than the predicted lowest amount of power generation that is specified from the probability distribution, a value for which the difference from the predicted lowest amount of power generation is greater than the predetermined value.

### Explanation of Operation

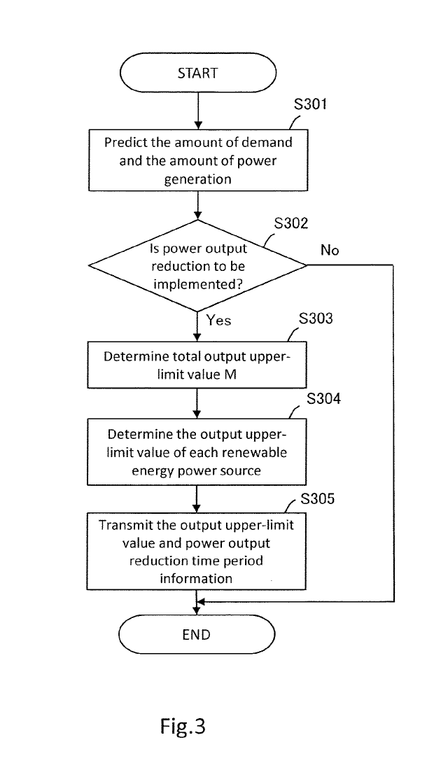

FIG. 3 is a view for describing a power output reduction process that uses electric power generation control device A.

A power company carries out a prediction of the amount of demand (amount of demand for electric power) of all consumers and the amount of power generation of each of all renewable energy power sources within the electric power system under its control for the time period from 0:00 to 24:00 of the following day (Step S301). In Step S301, the power company may also predict the amount of power generation by grouping the renewable energy power sources. The grouping is carried out on the basis of, for example, the contracted capacity, the region, or the power generation history of the renewable energy power sources. The prediction of the amount of demand of the consumers is carried out using the history of the amount of demand of the consumers. In addition, the prediction of the amount of power generation of renewable energy power sources is carried out using the power generation history of the renewable energy power sources. The time of carrying out prediction can be altered as appropriate. Here, the total number of renewable energy power source is “N”, and the identification information of the renewable energy power sources is “n” (where n is 1, . . . , N).

In order to realize stable supply of electric power, the amount of supplied electric power (amount of generated power) must be reduced in time periods in which the amount of supplied electric power (amount of generated power) exceeds the amount of demand for electric power.

When reducing the amount of supplied electric power by renewable energy power sources in an electric power system to which renewable energy power sources are connected, the amount of electric power supplied by sources other than the renewable energy power sources must first be reduced according to priority power supply rules.

It is here assumed that the generation of surplus power resulting from power generation using renewable energy will be predicted in the time period from 10:00 to 11:00 of the following day even after performing a reduction in power output of thermal power generation or the creation of demand by the pumping (pumping operation) of pumped storage power generation in accordance with the priority power supply rules.

The power company at this time judges that power output reduction (power generation reduction) of all renewable energy power sources will be necessary and at the stage of the previous day determines to execute a reduction in the output of power in all renewable energy power sources on the following day (Step S302). In a case in which surplus electric power originating in renewable energy power sources is to be resolved by controlling the thermal power generation or the pumping of pumped storage power generation according to priority power supply rules, implementing a reduction in the output of power in renewable energy power sources on the following day is postponed.

The power company, having determined to implement a reduction in power output, calculates the total output upper-limit value of all renewable energy power sources in the time period from 10:00 until 11:00 of the following day and takes this value as M (Step S303). Total output upper-limit value M of all renewable energy power sources indicates the target value for cancelling surplus power originating in the renewable energy power sources. If the total output of all renewable energy power sources is the total output upper-limit value M of all renewable energy power sources, the surplus power originating in the renewable energy power sources is cancelled.

Communication unit A1 acquires total output upper-limit value M of all renewable energy power sources and the prediction information of the amount of power generation that is expected to be generated from 10:00 to 11:00 of the following day at each renewable energy power source n. For example, a communication device (not shown) of the power company transmits total output upper-limit value M, and when the above-described prediction device transmits prediction information of each renewable energy power source n, communication unit A1 receives total output upper-limit value M from the communication device of the power company and receives the prediction information of each renewable energy power source n from the prediction device. Communication unit A1 supplies total output upper-limit value M and the prediction information of each renewable energy power source n to control unit A2.

The prediction information is here assumed to include not only the prediction value of the amount of power generation but also random variable Xₙ in probability space (Ω, P) that holds the prediction value as the expected value. The prediction information is an example of the probability distribution for the predicted amount of power generation of renewable energy power sources.

Control unit A2 calculates the output upper-limit value of each renewable energy power source n based on the information that was received from communication unit A1 (Step S304).

Control unit A2 next transmits, for each renewable energy power source, the output upper-limit value and power output reduction time period information (in this case, information indicating the time period from 10:00 to 11:00 of the following day) from communication unit A1 (Step S305).

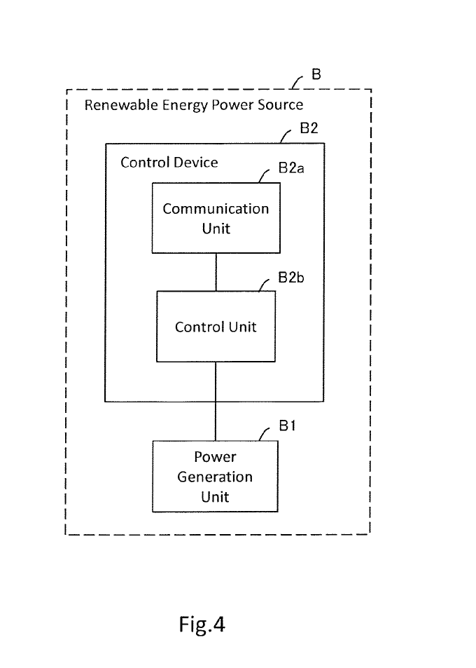

FIG. 4 shows an example of a renewable energy power source.

Renewable energy power source B includes power generation unit B1 and control device B2. Power generation unit B1 and control device B2 may be incorporated in the same housing, or may be separate. Power generation unit B1 is a device that generates electric power by using renewable energy such as a PV device or a wind power generation device. Control device B2 includes communication unit B2a and control unit B2b. Communication unit B2a is an example of a reception unit and receives an output upper-limit value and power output reduction time period information that are transmitted from electric power generation control device A. Control unit B2b receives the output upper-limit value and power output reduction time period information by way of communication unit B2a. Control unit B2b controls the reduction of output power of power generation unit B1 to the output upper-limit value or less in the power output reduction time period indicated by the power output reduction time period information. Power output reduction of each renewable energy power source B is implemented by the setting of the output upper-limit value of that renewable energy power source B.

The output upper-limit value of each renewable energy power source according to the present example embodiment is given as shown below.

Control unit A2 determines output upper-limit value rₙ that is given to each renewable energy power source on the basis of the total output upper-limit value M of all renewable energy power sources. However, because the amount of power to be generated the following day cannot be accurately known, the output realized by a renewable energy power source may not attain output upper-limit value rₙ in some situations. Output upper-limit value rₙ is hereinbelow also referred to as “rₙ”.

Because the power generation provider wishes to secure as much power generation output as possible, each output upper-limit value rₙ should be determined such that the sum total of the output renewable energy power sources after power output reduction matches the total output upper-limit value M of all renewable energy power sources.

To further clarify the problem that is to be solved, the following expected loss minimization is carried out.

$${Minimize}_{{r}_{1} , … , {r}_{N}} : {\int }_{Ω}^{ } \{ M - {\sum }_{n = 1}^{N} min ( {X}_{n} , {r}_{n} ) \} dP \\ subject to {\sum }_{n = 1}^{N} min ( {X}_{n} ( ω ) , {r}_{n} ) \leq M ( a \cdot a \cdot ω ∈ Ω ) \qquad [ Numerical Expression 1 ]$$

This solution is the optimum output upper-limit value rₙ for each renewable energy power source.

For example, assuming that random variables are mutually independent and that all probability density functions have bounded open intervals as supports, the Lagrangian method of an undetermined multiplier can be used to obtain an algorithm that derives an optimum solution that is uniquely determined.

The algorithm for determining the optimum output upper-limit value rₙ for each renewable energy power source while improving fairness among the renewable energy power sources is next described on the basis of the above-described assumptions.

### Step 1

Assuming Fₙ is a probability distribution function that random variable Xₙ obeys and Gₙ is the inverse function, the following function is defined:

G=Σₙ₌₁^{N}Gₙ. [Numerical Expression 2]

If the value of total output upper-limit value M of all renewable energy power sources is between the minimum value and maximum value of the total output of the renewable energy power sources, only one particular λ_{M} exists and satisfies G(λ_{M})=M.

If rₙ=Gₙ(λₘ), then this rₙ minimizes the expected loss.

On the basis of the total output upper-limit value M and the prediction information of the predicted power generation that are received from communication unit A1, control unit A2 calculates λ_{M} if the value of total output upper-limit value M is between the lowest value of the total output of the renewable energy power sources (the highest value among power generation amounts that are assumed at a probability of 100% to be generated at or above this level) and the highest value (the lowest value among power generation amounts that are assumed at a probability of 100% not to be generated at or above this level) and computes the output upper-limit value (first output upper-limit value) for each renewable energy power source by means of rₙ=Gn(λ_{M}). The lowest value of the total output is the sum total of the predicted lowest output of each renewable energy power source that is specified from the prediction information (probability distribution). Further, the highest value of the total output is the sum total of the predicted highest output of each renewable energy power source that is specified from the prediction information (probability distribution).

On the other hand, when the value of total output upper-limit value M is lower than the lowest value of the total output, control unit A2 can make rₙ=“(lowest output value of power generation device n)−αₙ” the output upper-limit value (second output upper-limit value) for each electric power generation device by using any positive number αₙ that satisfies the equation:

$${\sum }_{n = 1}^{N} \{ ( lowest output value of electric power generation device n ) - {α}_{n} \} = M . \qquad [ Numerical Expression 3 ]$$

The method of setting αₙ is here briefly described. Control unit A2 sets αₙ to reduce differences in degree of power output reduction among each of the renewable energy power sources. This setting of αₙ will be described in detail in Step 2, described hereinbelow.

Next, to proceed in the calculation of output upper-limit value rₙ, a case is considered in which the distribution of each Xₙ accords with:

σₙ⁻¹φ(σₙ⁻¹(x−μₙ)) [Numerical Expression 6]

for:

probability density function φ [Numerical Expression 5]

that satisfies:

{φ≠0}=(−1,1). [Numerical Expression 4]

Here:

μₙ≥σₙ. [Numerical Expression 7]

In this case, μₙ is average value μ of a renewable energy power source n and σₙ is dispersion value σ of renewable energy power source n.

At this time, according to the value of M, the optimum value of rₙ is given as shown below:

$$\begin{matrix} & [ Numerical Expression 8 ] \\ i . & \\ {\sum }_{n}^{ } ( {μ}_{n} - {σ}_{n} ) \leq M \leq {\sum }_{n}^{ } ( {μ}_{n} + {σ}_{n} ) ⇒ {r}_{n} = {μ}_{n} - \frac{{σ}_{n}}{{\sum }_{n}^{ } {σ}_{n}} ( {\sum }_{n}^{ } {μ}_{n} - M ) & \\ ii . & \\ M < {\sum }_{n}^{ } ( {μ}_{n} - {σ}_{n} ) ⇒ {r}_{n} = {μ}_{n} - {σ}_{n} - {α}_{n} . & \end{matrix}$$

However, αₙ of “ii.” is any positive number that satisfies:

$$\begin{matrix}{\sum }_{n}^{ } {r}_{n} = M . & [ Numerical Expression 9 ] \\ Here \text{:} & \\ \frac{{σ}_{n}}{{\sum }_{n}^{ } {σ}_{n}} ( {\sum }_{n}^{ } {μ}_{n} - M ) & [ Numerical Expression 10 ]\end{matrix}$$

of i is an example of the adjustment value.

### Step 2

For a power generation business, whether power output reduction is regarded as fair compared to other businesses is an important issue. Here, fairness among power generation devices is appraised using a power generation device utilization rate that takes as a standard the annual average amount of power generation for each area:

[average total amount of power generation per day of power generation device n to date following implementation of power output reduction]/[annual average amount of power generation per day of power generation device n in non-power output reduction state] [Numerical Expression 11]

“Power generation device” here refers to a renewable energy power source. Days that are the objects of appraisal are limited to days in which power output reduction is implemented. The power generation device utilization rate is an example of the ratio of the amount of power generation of a power generation device in a state in which power output reduction is being applied with respect to the amount of power generation of the power generation device in a state in which power output reduction is not being applied. The power generation device utilization rate refers to the degree of power output reduction of a power generation device.

Control unit A2 then adjusts αₙ in Step 1 such that the dispersion of past averages of the power generation device utilization rate in each power generation device is reduced in the next day of implementing power output reduction. The adjustment method may employ a dispersion minimization condition or may use a different adjustment index. According to this method, fairness can be maintained or improved in a form that does not affect the reduction of the amount of power output reduction.

The effect of the present example embodiment is next described.

The power output reduction system of the present example embodiment of a power generation device (renewable energy power source) that uses renewable energy to generate electric power exhibits the effect of circumventing the risk of sudden drops in the amount of power generation due to, for example, the weather because the output level of each power generation device is determined while taking into consideration the ease of successfully predicting the amount of power generation.

An example of the effects is shown below.

In a typical case, the minimum value of the expected value of power generation loss following implementation of power output reduction is given by:

$${\sum }_{n = 1}^{N} {\int }_{- ∞}^{{r}_{n}^{*}} {F}_{n} ( x ) dx . \qquad [ Numerical Expression 12 ]$$

Here, the value:

rₙ* [Numerical Expression 13]

is the optimum output upper-limit value for each power generation device. For example, a case is considered in which the distribution of each Xₙ accords with:

σₙ⁻¹φ(σₙ⁻¹(x−μₙ)) [Numerical Expression 16]

for:

probability density function φ [Numerical Expression 15]

that satisfies:

{φ≠0}=(−1,1). [Numerical Expression 14]

It is assumed that:

μₙ≥σₙ. [Numerical Expression 17]

Based on the preceding equations, the minimum value in this case becomes:

$${\int }_{L}^{1} ( x - L ) ϕ ( - x ) dx {\sum }_{n = 1}^{N} {σ}_{n} . \qquad [ Numerical Expression 18 ]$$

It is here defined that:

$$L = \frac{{\sum }_{n = 1}^{N} {μ}_{n} - M}{{\sum }_{n = 1}^{N} {σ}_{n}} . \qquad [ Numerical Expression 19 ]$$

In particular, assuming a simple triangular probability density function with the lower-side confidence interval width at 20% of the predicted value, if M is generally 90% of the total predicted output in all time periods that are the object of power output reduction, the power generation loss can be expected to be reduced at:

M/72≈(1.4% of M). [Numerical Expression 20]

This system has extremely high versatility and can operate regardless of the predicted probability distribution form in use.

The power output reduction system of the power generation that uses renewable energy of the present example embodiment has means that uses the predicted power generation probability distribution of renewable energy power sources to determine the power output reduction level of each renewable energy power source. Taking as a standard a threshold value that is determined by the shape of the prediction probability distribution (the sum total of the predicted lowest output of each renewable energy power source), this system then implements power output reduction control that switches the degree of priority of improving fairness and minimizing the power output reduction amount when total power output reduction amount M is less than, or is equal to or greater than the threshold value.

According to the present example embodiment, opportunities for power sales increase for the power generation business. This effect is realized because, by taking into consideration the uncertainty of the power generation of a renewable energy power source in the form of probability distribution in planning beforehand, the expected value minimization is theoretically guaranteed from the standpoint of minimizing the amount of power output reduction and maximizing the amount of power generation after power output reduction can be accurately realized.

In addition, the present example embodiment enables power generation with a high level of fairness among power generation businesses or among a plurality of power sources owned by power generation businesses. This effect is obtained because power output reduction can be implemented while switching between fairness and minimization of the power output reduction amount by using confidence intervals that reflect sufficient confidence to set a threshold value.

### Second Example Embodiment

FIG. 5 is a block diagram showing electric power generation control device Aa of the second example embodiment of the present invention. In FIG. 5, elements having a configuration that is identical to elements shown in FIG. 1 are given the same reference numbers.

Electric power generation control device Aa includes communication unit A1 and control unit A2a. Control unit A2a is an example of the determination unit. In addition to the functions possessed by control unit A2 shown in FIG. 1, control unit A2a is provided with new functions that will be described hereinbelow. The second example embodiment is next described with focus on the new functions.

In the first example embodiment, control unit A2 uses the probability distribution of power generation prediction as shown in Numerical Expressions 4-9 to determine the output upper-limit value of each renewable energy power source.

However, when the reliability of the probability distribution of power generation prediction is low, using a probability distribution to determine the output upper-limit value of each renewable energy power source as shown in the first example embodiment is assumed to be difficult.

Low reliability of a probability distribution is equivalent to large dispersion σ of distribution, and when:

σₙ=μₙ [Numerical Expression 21]

the reliability is lowest. At this time, the output upper-limit value of each renewable energy power source is given by:

$${r}_{n} = {μ}_{n} - \frac{{σ}_{n}}{{\sum }_{n}^{ } {σ}_{n}} ( {\sum }_{n}^{ } {μ}_{n} - M ) = \frac{{μ}_{n}}{{\sum }_{n}^{ } {μ}_{n}} M . \qquad [ Numerical Expression 22 ]$$

In Numerical Expression 22, only average value μ (the predicted amount of power generation of a power generation device) that is a prediction value and total output upper-limit value M are used and information of dispersion value σ is not entered.

As a result, when the smallest dispersion value σ among the dispersion values σ of a plurality of renewable energy power sources is equal to or greater than a predetermined value, control unit A2a uses total output upper-limit value M and average value μ without using dispersion value σ to determine the output upper-limit value of each renewable energy power source in accordance with Numerical Expression 22. On the other hand, when the smallest dispersion value σ among the dispersion values σ of a plurality of renewable energy power sources is less than the predetermined value, control unit A2a determines the output upper-limit value of each renewable energy power source as shown in the first example embodiment.

An power output reduction system of power generation devices (renewable energy power sources) that use renewable energy to generate power according to the present example embodiment determines the output level of each power generation device by taking into consideration the prediction of the amount of power generation and thus exhibits the effect of circumventing the risk of sudden drops in the amount of power generation due to, for example, the weather.

Control unit A2a may always determine the output upper-limit value of each renewable energy power source in accordance with Numerical Expression 22. In this case, communication unit A1 should receive the total output upper-limit value M and the average value μ of each renewable energy power source. Here, average value μ of each renewable energy power source is an example of the predicted amount of power generation of each renewable energy power source, but a simple expected amount of power generation of each renewable energy power source, and not average value μ of each renewable energy power source, may be used as the predicted amount of power generation of each renewable energy power source that is received by communication unit A1.

### Third Example Embodiment

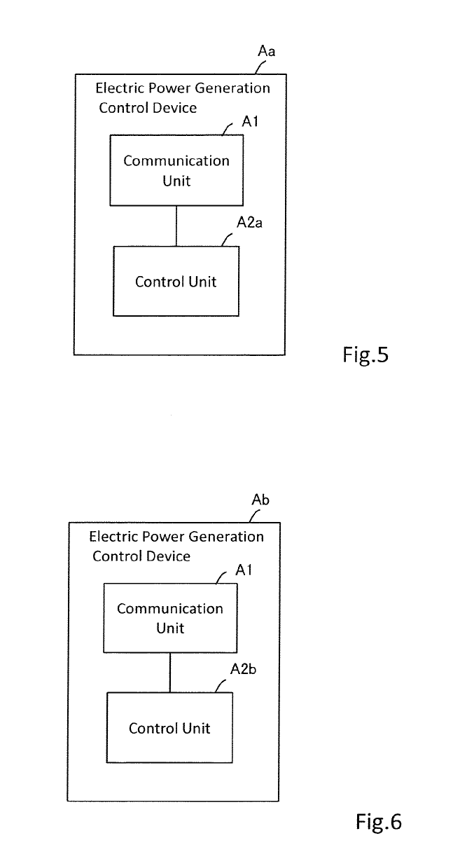

FIG. 6 is a block diagram that shows electric power generation control device Ab of the third exemplary embodiment of the present invention. In FIG. 6, elements having the same configuration as elements shown in FIG. 1 are given the same reference numbers.

Electric power generation control device Ab includes communication unit A1 and control unit A2b. Control unit A2b is an example of the determination unit. Control unit A2b is provided with, in addition to the functions possessed by control unit A2a shown in FIG. 5, new functions that are to be described later. The third example embodiment is described hereinbelow with focus on the new functions.

When power generation prediction is not executed normally to begin with such as when an abnormality occurs in, for example, the prediction device that carries out the power generation prediction, the prediction information cannot be used at all when making an output control plan of a renewable energy power source in advance. In such a case, to the extent possible, the use of a value that is close to the output upper-limit value that is given in the first example embodiment or second example embodiment to determine the output upper-limit value of each renewable energy power source is desirable from the standpoint of maximizing total output while carrying out power output reduction.

Here, the probability is high that the size of the power generation prediction value will be basically proportional to the rated output or the contracted capacity (contracted output capacity) for the output capacity of renewable energy power sources. As a result, if the contracted capacity or rated output is used to carry out setting of the output upper-limit value, a value can be obtained that is close to the set value that is calculated in Numerical Expression 21.

When communication unit A1 is unable to receive the probability distribution of the power generation prediction amount of each renewable energy power source (predicted amount of power generation), control unit A2b determines the output upper-limit value of each renewable energy power source on the basis of total output upper-limit value M and contracted capacity Mₙ of renewable energy power source n that is determined in advance in accordance with:

$${r}_{n} = \frac{{M}_{n}}{{\sum }_{n}^{ } {M}_{n}} M . \qquad [ Numerical Expression 23 ]$$

The contracted capacity of renewable energy power source n is an example of the possible output capacity of a renewable energy power source that has been determined in advance. Control unit A2b holds contracted capacity Mₙ of each renewable energy power source n in advance. Alternatively, the rated output of each renewable energy power source n may also be used in place of contracted capacity Mₙ of each renewable energy power source.

Cases in which communication unit A1 is unable to receive the probability distribution of the predicted amount of power generation of each renewable energy power source include cases in which communication unit A1 is unable to receive the probability distribution of the predicted amount of power generation of each renewable energy power source for a predetermined interval, and cases in which communication unit A1 is unable to receive all probability distributions of the predicted amount of power generation of each renewable energy power source. In addition, cases in which communication unit A1 is unable to receive the probability distribution of the predicted amount of power generation of each renewable energy power source are assumed to further include cases in which a portion of a probability distribution is missing or cases in which the probability distribution is in an abnormal state (is a case that somewhat differs from a probability distribution).

When communication unit A1 has received the probability distribution of the predicted amount of power generation of each renewable energy power source (power generation prediction amount), control unit A2b determines the output upper-limit value of each renewable energy power source as shown in the second example embodiment.

The power output reduction system of a power generation device (renewable energy power source) that uses renewable energy to generate power of the present example embodiment determines the output level of each power generation device on the basis of total output upper-limit value M and the contracted capacity of each renewable energy power source. As a result, the effect is exhibited in which the total power generation amount can be maintained with a certain degree of stability even when the prediction of the power generation amount cannot be acquired as long as there is no sudden change in weather.

Control unit A2b may also always determine the output upper-limit value of each renewable energy power source in accordance with Numerical Expression 23. In this case, communication unit A1 should receive total output upper-limit value M.

In each of the above-described example embodiments, electric power generation control devices A, Aa, and Ab may also be realized by a computer. In this case, a computer reads and executes a program that is recorded on a recording medium that can be read by a computer to execute the functions possessed by electric power generation control device A. The recording medium is, for example, a CD-ROM (Compact Disk Read Only Memory). The recording medium is not limited to a CD-ROM and can be altered as appropriate.

In each of the above-described example embodiments, the configurations shown in the figures are merely examples, and the present invention is not limited to these configurations. For example, control unit A2, B2b, A2a, and A2b may be realized by a processor.

Although the invention of the present application has been described with reference to example embodiments, the invention of the present application is not limited to the above-described example embodiments. The configuration and details of the invention of the present application are open to various modifications within the scope of the invention of the present application that will be clear to one of ordinary skill in the art. This application claims the benefits of priority based on Japanese Patent Application No. 2015-107738 for which application was submitted on May 27, 2015 and incorporates by citation all of the disclosures of that application.

### EXPLANATION OF REFERENCE NUMBERS

A, Aa, Ab electric power generation control device
A1 communication unit
A2, A2a, A2b control unit
B renewable energy power source
B1 power generation device
B2 control device
B2a communication unit
B2b control unit

1. An electric power generation control device comprising:
a communication unit that receives an output upper-limit value in a power generation device group and a predicted amount of power generation of each power generation device that belongs to said power generation device group; and
a determination unit that, on the basis of said output upper-limit value and the predicted amount of power generation of each of said power generation devices, determines a first output upper-limit value of each of said power generation devices that makes the sum total of the outputs of each of said power generation devices equal to or less than said output upper-limit value.

2. The electric power generation control device according to claim 1, wherein the predicted amount of power generation of each said power generation device is the average value of the predicted amount of power generation of each said power generation device that is specified by the probability distribution of the predicted amount of power generation of each said power generation device.

3. The electric power generation control device according to claim 2, wherein:
said communication unit further receives, for each said power generation device, a dispersion value of the predicted amount of power generation that is specified in the probability distribution of the predicted amount of power generation of that power generation device; and
said determination unit determines a first output upper-limit value of each said power generation device on the basis of the output upper-limit value in said power generation device group and the average value and dispersion value of the predicted amount of power generation of each said power generation device.

4. The electric power generation control device according to claim 3, wherein:
said determination unit determines for each said power generation device, as said first output upper-limit value of that power generation device, a value obtained by subtracting an adjustment value that accords with the dispersion value of the predicted amount of power generation of that power generation device and the output upper-limit value in said power generation device group from the average value of the predicted amount of power generation of that power generation device.

5. The electric power generation control device according to claim 4, wherein said determination unit increases said adjustment value in proportion to the power generation device for which said dispersion value is great among the plurality of power generation devices that belong to said power generation device group.

6. The electric power generation control device according to claim 3, wherein said determination unit, when the smallest dispersion value among the dispersion values of the predicted amount of power generation of said plurality of power generation devices is equal to or greater than a predetermined value, determines a first output upper-limit value of each said power generation device on the basis of the output upper-limit value in said power generation device group and the average value of the predicted amount of power generation of each said power generation device without using said dispersion value.

7. The electric power generation control device according to claim 3, wherein said determination unit further, on the basis of the output upper-limit value in said power generation device group and the average value and dispersion value of the predicted amount of power generation of each said power generation device, determines a second output upper-limit value of each said power generation device that reduces the difference of the degree of power output reduction among each of said power generation devices and further makes the sum total of the output of each of said power generation devices equal to or smaller than said output upper-limit value.

8. The electric power generation control device according to claim 7, wherein:
said communication unit receives the probability distribution of the predicted amount of power generation of each said power generation device; and
said determination unit determines a second output upper-limit value of each said power generation device when the output upper-limit value in said power generation device group is lower than the sum total of the lowest predicted output of each of said power generation devices that is specified from said probability distribution.

9. The electric power generation control device according to claim 8, wherein said determination unit determines a first output upper-limit value of each said power generation device when the output upper-limit value in said power generation device group is a value between the sum total of the lowest predicted output of each of said power generation devices that is specified from said probability distribution and the sum total of the highest predicted output of each of said power generation devices that is specified from said probability distribution.

10. The electric power generation control device according to claim 7, wherein the degree of power output reduction of said power generation device is the ratio of the amount of power generation of that power generation device in a state in which power output reduction is being implemented with respect to the amount of power generation of that power generation device in a state in which power output reduction is not being implemented.

11. The electric power generation control device according to claim 1, wherein when said communication unit is unable to receive the predicted amount of power generation of each of said power generation devices, said determination unit determines a first output upper-limit value of each said power generation device on the basis of the output upper-limit value in said power generation device group and the possible output capacity of each said power generation device that is determined in advance.

12. The electric power generation control device according to claim 11, wherein the possible output capacity of each said power generation device is the contracted output capacity of each said power generation device.

13. The electric power generation control device according to claim 7, wherein said communication unit transmits a first output upper-limit value or a second output upper-limit value of each said power generation device to each said power generation device.

14. (canceled)

15. A control device comprising:
a reception unit that receives said first output upper-limit value or said second output upper-limit value from the electric power generation control device as set forth in claim 13; and
a control unit that reduces output of a power generation unit to no more than an output upper-limit value that was received.

16. A control method comprising steps of:
receiving an output upper-limit value in a power generation device group and the predicted amount of power generation of each power generation device that belongs to said power generation device group; and
on the basis of said output upper-limit value and the predicted amount of power generation of each said power generation device, determining a first output upper-limit value of each of said power generation devices that makes the sum total of the output of each of said power generation devices equal to or less than said output upper-limit value.

17. (canceled)
